(19) United States
(12) Patent Application Publication
(10) Pub. No.: US 2004/0237253 A1
(43) Pub. Date: Dec. 2, 2004

(54) Sliding rotating support system

(75) Inventors: Stacey V. Ellison, Temecula, CA (US); Ian Clive McPartland, Carlsbad, CA (US); Daniel Nicholas Beattie, Yarm (GB)

Correspondence Address: Stacey V. Ellison, 29589 Hazel Glen Road, Temecula, CA, 92563, US

(73) Assignees: Stacey V. Ellison, Temecula, CA; Ian Clive McPartland, Carlsbad, CA; Daniel Nicholas Beattie, Yarm (GB)

(21) Appl. No.: 10/829,859

(22) Filed: Apr. 22, 2004

Related U.S. Application Data
(60) Provisional application No. 60/464,738, filed on Apr. 24, 2003.

(51) Int. Cl. E05D 15/00

(52) U.S. Cl. 16/87.8

(57) ABSTRACT

A device for the sliding and rotating suspension of supported elements (3) of variable dimensions which are constrained between two running profiles (1, 2) to facilitate the sliding motion desired and by a system of adjustable holding profiles (4) and adjustable coupling systems (5, 17, 31, 32) which include rotational and rolling components (9, 12, 14, 19, 20) to facilitate the required sliding and rotation of elements (3) and to variably distribute a variety of loads induced upon the system as required. Required rotation of elements (3) is facilitated by the partial removal of variable lengths of running profiles (35, 36) and by the addition of locking structures (21, 25) and by engaging structures (23, 26), partially comprising the coupling mechanisms (5, 17, 31, 32) to control the availability of rotational motion to the supported elements (3) and to control the availability of horizontal motion as is required.

### CROSS REFERENCE TO RELATED APPLICATIONS

Right of priority is claimed from provisional patent application No. 60/464,738 filed Apr. 24, 2003 and titled “Sliding and rotating support system”.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISK APPENDIX

Not Applicable

### BACKGROUND OF THE INVENTION

Herewith is contained an invention that relates to an arrangement to facilitate the sliding and rotating of a supported element or system of elements.

It is known from prior art that sliding element systems of similar function exist from references U.S. Pat. No. 5,448,855 and U.S. Pat. No. 6,487,753. A typical arrangement of such a system comprises two opposing rails to facilitate the movement of elements through the use of bonded profiles and facilitative mechanisms. Said systems are typically implemented using glass elements to provide transparent and configurable partitions. Sliding element systems known from the prior art typically utilize a facilitative mechanism comprising a system of rotational or rolling components installed to align and constrain elements within said opposing rails and to facilitate movement. Strategic removal of fixed-dimensioned portions of the opposing rails along a plane parallel with the direction of motion of the supported elements to create exit holes, and together with inclusion of locking mechanisms to limit said motion of elements when their direction of alignment no longer corresponds with the direction of preferred movement results in the ability to swing such supported panels away from the opposing rails and stack to one side, so facilitating the movement of subsequent panels and providing a system that can be deployed as required once installed.

Notwithstanding the present invention, such examples display as a characteristic of design the requirement for a precise alignment in the positing of elements and facilitative mechanisms with respect to the extent of the opposing rails both horizontally and vertically. Such examples also display as a characteristic of design the requirement for a precise alignment of said running profiles with respect to each other vertically, horizontally and also transversely. Such systems present many difficulties in implementation even in soundly designed installations. Glass panels of the type used in such systems present a variety of variations in length, width thickness and flatness as an intrinsic result of the nature of glass fabrication that can interfere with or even preclude the ability of such systems to maintain alignment of facilitative elements with respect to the opposing rails.

Even when such variations are minimized and overcome, the nature of such exampled systems require the positioning of the facilitative mechanisms to be unique to each installed sliding element in a processional manner to enable the rotation of the elements out of the aforementioned fixed-dimensioned exit holes and result in limitations being imposed on the range of situations such systems can be installed in. Such systems must be distanced sufficiently from existing walls, balustrades and other such pre-existing structures and the unique, processional, positioning of each facilitative mechanism with respect to the elements places a limit on the number of elements supported by a single pair of fixed-dimension exit holes and so a succession of individual fixed-dimension exit holes must be created in the opposing rails to facilitate larger installations. Such examples also require a protruding arm-like appendage be located at the point of every upper exit hole of the opposing rails to support the rotating elements before aforementioned locking mechanisms become fully engaged without which support elements would collapse from the track system and present a possible safety hazard. As a consequence the varied theoretical situations such systems can be envisioned as deployed or utilized in are often precluded, or limited in implementation, by real world circumstances and the many unique situations that can be presented in such circumstances.

In such examples individual elements are also subject to unique forces as an intrinsic result of the nature of such systems. Where elements are supported along only two edges and these edges are supported only by discreet facilitative mechanisms large loads can be induced in the system resulting from dense or heavy element material, from larger sized elements and also from third party forces such as, for example, wind loads that can adversely affect the performance and required movement of supported elements resulting in limitations resulting from design of the size and nature of material that constitutes elements.

The former example system cited overcomes such problems by distributing the loads induced between both opposing rails and so further reducing the tolerances required with respect to the placement of each opposing rail relative to both each other and relative to the facilitative mechanisms present upon the elements to create a working system. This system also limits the number of possible deployment situations by inducing loads on both lower and upper structures and precluding use of the system in conjunction with, for example, hung ceilings. The latter example system cited overcomes such problems by transferring load focus to the lower opposing rail of the system which can result in a degradation of the desired movement of supported elements induced by friction within the system with respect to the supporting rails and the facilitative mechanisms caused by increasing load induced upon the elements by said unique forces present in systems of this nature from, for example, heavier elements and by a potential reduction of performance in the system to operate correctly when lateral loads are present.

Lesser functional variants of the type of systems illustrated above exist in prior art referenced by U.S. Pat. No. 4,845,806. Furthermore, similarly functional systems exist with similar functions and drawbacks where variation is expressed largely through differing construction of the facilitative mechanisms by means of the number of rotational components and their positioning relative to both each other and other parts of the system and are referenced by U.S. Pat. No. 6,702,271.

### BRIEF SUMMARY OF THE INVENTION

The present invention is an implementation of a sliding and rotating suspension system designed to overcome the drawbacks of existing systems and to provide a system that operates correctly under a wide range of varying loads induced by different solutions of element size and material, and that results in a system that can cope with a wide range of real world situations with respect to varying element types and installation locations.

The present invention is illustrated as consisting of two running profiles mounted oppositely, with respect to each other, and which includes a series of elements held by a device with a lateral extent that holds the elements and provides a platform for the deployment of a set of coupling mechanisms that facilitate the sliding and rotational movement desired of the supported elements. The holding device as outlined in the detailed description imparts the ability to securely and accurately hold a range of element materials with respect to, for example, size and material. The coupling mechanisms at the typically lower edge of the elements are comprised substantively of a spherical transfer unit and two discreet rotational elements. The typically upper coupling mechanisms are comprised substantively of two rotational elements. The running profiles comprise a longitudinal slot to facilitate the constrainment of the coupling mechanisms, the walls of which are characterized by a system of laterally extending grooves and protuberances formed to provide points of contact with the coupling mechanisms in accordance with the design of the invention. The coupling mechanisms are thus engaged with the running profiles to facilitate the desired distribution of the load induced by the elements.

Namely, that the majority of the load induced is conveyed on the lower spherical transfer unit and the rotational elements are individually engaged only omni-laterally with respect to the running profiles. The present invention calls for rotational elements to be deployed in complementary pairs and so enables the free rotation of the rotational elements in opposite directions with respect to each other to facilitate the free, quiet and efficient guidance of the elements along the longitudinal slot of the running profiles under a variety of different load conditions by ensuring each rotational element is reserved for engagement with only one wall of the running profile slots. Thus continued optimal conveyance of the elements is ensured even when unwanted lateral load is applied to the system.

Additionally, by positioning the rotational elements within the system in different configurations with respect to the central shaft of the coupling mechanisms, and when viewed in conjunction with spring-like suspension elements used in the joining of the coupling system with the element holding device, the system can be induced to convey varying portions of the load induced by the elements as desired. Namely, load can then be spread between the spherical transfer units and the rotational components as desired to accommodate a range of differing load circumstances as required that may not otherwise be accommodated by said spherical transfer units alone. Simultaneously, this range of possible configurations characteristic of the present invention, when viewed in conjunction with the extending grooves and protuberances characteristic of the running profile slots result in an arrangement that provides flexibility in the finished system by ensuring accommodation of discrepancies resulting from less than perfect installation of the running profiles and flaws in the dimensional characteristics of elements and other components such as, for example, the varying dimensional qualities present in glass panels as a result of the glass production process. By increasing these critical tolerances with respect to the relative positioning of components, elements and running profiles in such a manner results in an easily installed and flexible system that has additional benefits in effective smooth running, and noise and vibration reduction.

The present invention also comprises a system of laterally extending engaging mechanisms located along the running profile slots. When viewed in conjunction with corresponding radial components comprising parts of the coupling systems the rotational aspect of the movement of supported elements is facilitated. These laterally extending locking mechanisms provide a means of constraining the motion of the elements to correspond with the direction of the longitudinal extent of the running profiles, even in the event of partial removal of sections of one half of the running profiles, and to dictate the location at which individual elements are able to rotate and partially disengage from the running profiles. As a consequence, larger exit holes can be formed in the running strips that are not required to possess fixed-dimension characteristics without premature disengagement of the elements occurring, even when unwanted laterally forces are applied to the system. Said locking mechanisms result in the ability to locate coupling mechanisms in a uniform manner with respect to the elements to be conveyed and so facilitate the ability of the present invention to be installed in locations very close to pre-existing structures such as, for example, balustrades and walls while still retaining the ability to convey elements around corners and curves in a plethora of different configurations and situations.

Furthermore, the cylindrical nature of the upper locking mechanism and the corresponding cylindrical components comprising the coupling mechanisms result in a system than fully engages with the elements to prevent the collapse of rotated elements even when only a few degrees of rotation of the rotating occurs, and so precludes the requirement for a system of appendages to support said elements until sufficient rotation has occurred to engage locking. Without this additional ability the use of variable-dimensioned exit-holes would be unable to facilitate rotation of the supported elements and so negate the benefits detailed in the preceding paragraph.

The detailed description outlined hereinafter will make apparent further innovations to outline the scope and arrangement of the present invention. Whilst the detailed description given does instruct on the preferred embodiment of the present invention, as is noted below this is only the preferred embodiment of the present invention and is merely illustrative of one application of the given invention, not limitative, and additional applications of the present invention are possible.

### BRIEF DESCRIPTION OF THE SEVERAL VIEWS OF THE DRAWING

The invention will be more fully understood when the detailed description given below is viewed in conjunction with the accompanying drawings, which are provided for illustrative purposes only, and are not limitative of the present invention in any way, and where:

FIG. 1 shows a sectional view through the locking coupling mechanisms taken on a plane bisecting the running profiles showing in the preferred embodiment that part of the system where the elements are pivotally suspended.

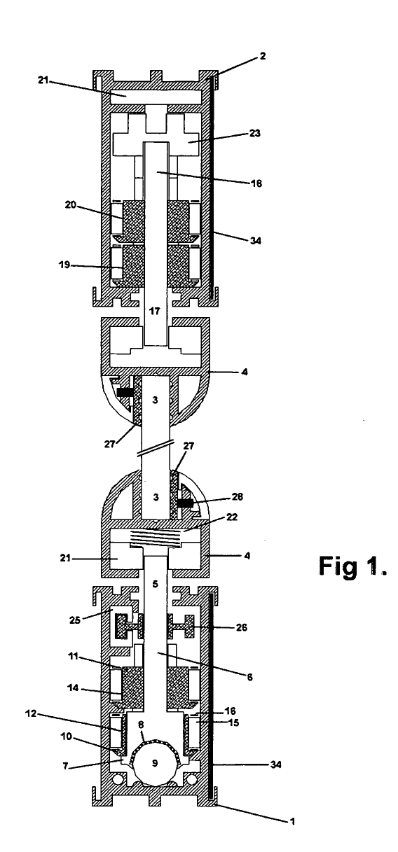

FIG. 2 shows a sectional view through the opening coupling mechanisms taken on a plane bisecting the running profiles showing in the preferred embodiment that part of the system where the elements are removed from the running profiles.

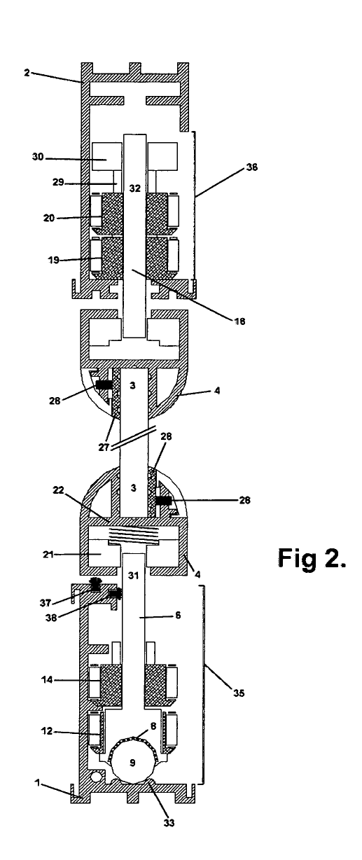

### DETAILED DESCRIPTION OF THE INVENTION

The invention relates to a system that enables the sliding and pivoting of supported elements such as, but not limited to, glass panels for enclosing a balcony, patio or terrace. The system can also be used however to support elements of any suitable material such as, but not limited to, plastics, metals and wood. The implemented invention leads to a system that can be used, preferably, to create an enclosure, a division or a partition consisting of a series of usually vertical elements which can slide and pivot to facilitate the stacking of said elements to one side and so provide a number of possible configurable arrangements in the finished article.

In the preferred embodiment the system comprises two running profiles (1, 2) secured in parallel with respect to one another and affixed to the surfaces between which the partition is required to be placed. The partition is comprised of a series of elements (3), preferably glass panels, which are bound within two sections of holding profile (4), the length of each piece of said holding profile being preferably equal to the width of said panels. The holding profiles (4) are affixed to each end of the elements (3) along the edges to be positioned parallel to the running profiles (1, 2). In the preferred embodiment, the elements (3) are secured within the holding profile (4) in conjunction with a retaining piece (27) formed in such a way that a firm hold upon the element (3) is achieved through the use of spaced-apart fasteners (28) fixed through an upwardly protruding flange formed as a preferably integral part of the holding profile (4), and so creating an adaptable fastening system that possesses the ability to secure elements of varying thickness while still maintaining maximum compressive hold.

Affixed to each holding profile (4) are four coupling systems (5, 17, 31, 32), preferably located at either end of the holding profiles. The coupling systems (5, 17, 31, 32) secure the elements (3) between the running profiles (1, 2), in the manner outlined below, and facilitate the movement, both horizontal sliding and rotational pivoting, of the elements (3). As a result of the confinement of the coupling systems (5, 17, 31, 32) within the interior longitudinal slot of the running profiles (1, 2) coupled with the omni directional nature of the movement of ball (9), the elements are guided along said running profiles (1, 2) around corners and curves. To enable said sliding of the elements (3), partial removal of sectional lengths (35) of the running profiles (1, 2) results in the ability to rotate and partially disengage elements (3) from within the running tracks (1, 2).

In the preferred embodiment, the lower coupling system (5, 31) comprises a central shaft (6), to the bottom of which is affixed a preferably cylindrical housing (7), with a protruding rim on its lower edge. The housing contains a number of spherical balls (8), of equal size, and a larger spherical ball (9) which protrudes through a circular hole in the bottom of the housing (7). The larger ball (9) is positioned so as to prevent the smaller balls (8) from exiting the housing (7) through said circular hole, and so provide a sealed system, which bears partially the load induced by the sliding elements (3), comprising a partially protruding freely-rotating ball (9), and a number of smaller balls (8) to facilitate the unrestricted omni directional rolling of said larger ball (9), and thus facilitate the longitudinal movement and rotational pivoting of the elements (3).

In the preferred embodiment, resting on the protruding rim on the exterior of the ball housing unit (7), positioned so as its rotational axis is parallel with the central shaft (6), is a shaped, preferably plastic spacer (10), the function of which is to provide a smooth, quiet, running surface for rotational element (12). A similar shaped spacer (11) is positioned around the central shaft (6) between the housing unit (7) and the holding profile (3). Furthermore, said spacers (10, 11) possess protruding rims with a tapered edge on the lower side which engage with corresponding protruding tapered sections on the interior of the running track (1), and when positioned correctly with respect to the central shaft (6) and the running track (1), will carry a portion of the load induced by the weight of the sliding elements (3). Said rotational elements (12, 14) have an outside diameter equal to the inside width of the running profile (1), and possess many individual rotating elements (15) held within a cage-like housing (16), so facilitating a smooth and quiet motion and provide lateral stability with respect to the sliding of the elements (3), and so minimize extraneous pivoting about the ball (9) which can increase friction and apply stress forces to sliding elements in similar systems.

In the preferred embodiment, the upper coupling system (17, 32) comprise a central shaft (18), around which are affixed preferably two rotational elements (19, 20), similar in form and function to the lower rotational element (14), and which further reduce the ability of the elements (3) to extraneously pivot about the ball (9). Varying the position of the components comprising the coupling systems (5, 17, 31, 32) with respect to the central shafts (6, 18) and with respect to one another facilitates a number of possible configurations of the distribution of the load induced by the elements (3), increasing the adaptability of the system. In the preferred embodiment, joining of the coupling systems (5, 17, 31, 32) with the holding profile (4) is facilitated through a fixing element (21), incorporating a suspension element (22) that enables vertical movement of the coupling systems (5, 17, 31, 32) with respect to each other and to the elements (3) and thus increases the durability and resilience of the system through increasing the tolerance of positioning of said running profiles (1, 2) and/or positioning of said coupling systems (5, 17, 31, 32) with respect to one another, whilst simultaneously reducing vibration and associated noise produced by movement of the elements (3) within the system.

In the preferred embodiment, a locking washer (23) is fixed to the upper central shaft (18) of the coupling mechanism (17) upon which the element (3) will rotationally pivot, and which possesses a lateral slot bisecting its upper surface aligned parallel with respect to the running tracks (1, 2) when the coupling mechanisms (5, 17, 31, 32) are fully engaged within the slots. A flanged locking strip (24) of the required length is secured within the upper running profile (2), and said flange possesses a width which does not exceed the width of the bisecting slot of the locking washer (23). Furthermore, the flange has slots, each possessing a width that exceeds the diameter of the locking washer (23) and that are positioned in a predetermined spaced-apart relationship along the length of said locking strip (24) in such manner so as to prevent the horizontal movement of the upper coupling mechanism (17) along the running profile (2) when the element (3), and hence the locking washer (23) are rotated and the outer coupling mechanisms (31, 32) are disengaged from said running profile (2), so as to prevent the tilting of the element (3) that can result if such horizontal movement is not prevented. The lower part of the locking washer (24) has a diameter preferably greater than the upper part, and preferably equal to the inside width of the upper running profile (2), which removes the ability of the upper coupling mechanism (17) to exit the running profile (2) through the upper slot (36) and so prevent the element (3) from completely disengaging from said running profile (2).

In the preferred embodiment, a lower locking strip (25) of the required length is fixed within the lower running track (1) and engages with a lower locking washer (26). Said locking washer (26) has a radial extent, with a slot aligned preferably parallel with respect to the running tracks (1, 2) when the coupling mechanisms (5, 17, 31, 32) are fully engaged within the slots, to facilitate said engagement. Said locking strip (25) has slots that are positioned in a predetermined spaced-apart relationship along the length of said locking strip (25) enabling the rotation of the locking washer (26) only at predetermined points, so as to prevent premature exit of the coupling mechanism (5) from the running profile (1) through the slot (35) via rotation of the element (3). To facilitate this mechanism, said locking washer (26) possesses a radial slot formed in such a way as to facilitate the engagement of the locking washer (26) with the locking strip (25) even when the element (3) is rotated and so preclude the locking coupling mechanism (5) from ever exiting the lower running profile (1) via the slot (35). The combination of the upper and lower locking strips (24, 25) and locking washers (23, 26) result in the elements (3) being fully locked in position, with respect to any sliding motion within the running profiles (1, 2), whilst they are rotated and stacked at any angle relative to the running profiles (1, 2).

In the preferred embodiment, the coupling systems (5, 17, 31, 32) can be arranged in the same position on every holding profile (4), resulting in the ability of the elements (3) to be mounted within, for example, a pre-existing railing, balustrade or other obstruction and still retain the ability to traverse corners and curves. This will necessarily result in the need for a larger slot (35, 36) to be incorporated into the running profiles (1, 2). Said upper and lower locking systems result in the ability to incorporate larger slots (35, 36) into the system without the associated problems concerning exiting of the locking coupling mechanisms (5, 17) from the running profiles (1, 2). Furthermore, through the use of variable numbers of spacers (29) and a radial guide piece (30), which has a diameter no greater than the inside width of the upper running profile (2) and through forming the upper slot to include sections of varying height, in a predetermined spaced-apart manner, said spacer(s) (29) and guide piece (30) dictate the lateral location at which the upper exiting coupling device (32) can exit the running profile (2), and so precluding premature rotation. Furthermore by selective removal of sections of the lower guide groove (33) in a predetermined manner, the lower exiting coupling mechanism (31) can be retained within the running profile (1) through contact with the running ball (7) and so further aid in preventing the premature egress of the coupling mechanisms (5, 17, 31, 32) that can occur in other systems. Use of sliding telescoping sections (34) result in the sealing of the exit slots (50 51) to provide lateral resistance to the coupling mechanisms (5, 17, 31, 32) whilst the rotational function of the system is not required, and also work in conjunction with the judicious use of seals (37, 38) to protect the interior of the running tracks (1, 2) from the effects of the weather.

What is claimed is:

1) A device for the sliding and rotating support of sheet elements consisting of:
A pair of running profiles arranged in parallel with respect to one another and each comprising a longitudinal slot defined by a system of inwardly projecting and laterally extending grooves and protuberances to form a substantially hollow transverse section.
A variable number of substantially sheet-like elements constrained along two edges by upper and lower rail like holding profiles comprising a pair of mutually corresponding elements joined together by way of their corresponding shapes and regularly placed joining devices.
A variable number of engaging and otherwise coupling mechanisms secured to said upper and lower holding profiles and joined by way of formed components complementarily dimensioned with respect to the interior of the holding profiles and whereby said engaging and otherwise coupling systems number two per holding profile and comprise substantially a central shaft and a number of facilitating components arranged around said central shafts.
The lower engaging and otherwise coupling systems substantially comprise each a spherical transfer unit extending in the vertical direction to contact the base of the lower running profile and two substantially cylindrical and rotational components extending in the horizontal direction to each contact one wall of the lower running profile on opposing sides of the interior of the lower running profile.
The upper engaging and otherwise coupling systems substantially comprise each two substantially cylindrical and rotational components extending in the horizontal direction to each contact one wall of the upper running profile on opposing sides of the interior of the upper running profile.

2) The device according to claim 1 and wherein a locking device with a corresponding lateral projection with respect to the running profiles and possessing spaced vertical protuberances is located against the interior of said upper running profile and whereby a corresponding component with a substantially cylindrical and complementary extent is arranged around one engaging upper coupling mechanism central shaft of each element and whereby said device and said component correspond in a spatial manner resulting in the engagement of said element with said locking device upon rotation of said element and thereby precluding the ability of said element to move relative to said running profiles in the horizontal axis corresponding with the direction of lateral extent of said running profiles.

3) The device according to claim 1 and wherein a locking device with a corresponding lateral projection to the running profiles and possessing a substantially unshaped lateral profile projection and possessing spaced vertical protuberances is located against the interior of said lower running profile and whereby a corresponding component with a substantially cylindrical and complementary extent is arranged around one lower engaging coupling mechanism of each element and whereby said device and said component correspond in a spatial manner resulting in the engagement of said element with said locking device and thereby precluding the ability of said element to move relative to said running profiles in horizontally axis transverse to the direction of the lateral extent of said running profiles and whereby said device and said component correspond in a spatial manner resulting in the engagement of said element with said locking device upon rotation of said element and thereby precluding the ability of said element to move relative to said running profiles in the horizontal axis corresponding with the direction of lateral extent of said running profiles.

4) The device according to claim 1 and wherein the upper and lower coupling mechanisms are arranged upon said holding profiles substantially around the four comers of said element, in such a way as to preclude relative movement with respect to said running profiles in the horizontal axis corresponding with the direction of lateral extent of said running profiles, through contact of said rotational components along the substantially vertical extent of said rotational components induced by relative positioning of said elements along the extent of said running profiles and with respect to one another.

5) The device according to claim 1 and wherein said upper and lower engaging coupling mechanisms are arranged upon said holding profiles of said element, in such a way as to preclude relative movement with respect to said running profiles in the horizontal axis corresponding with the direction of lateral extent of said running profiles, through contact of said rotational components along the substantially vertical extent of said rotational components induced by relative positioning and rotation of said elements along the extent of said running profiles, and with respect to one another, whilst not precluding the ability of subsequent elements to rotate and simultaneously dictating the correct positioning of elements for rotation around an axis corresponding to a definite point upon the axis along the lateral extent of said upper running profile and a corresponding definite point upon the axis along the lateral extent of said lower running profile.

6) The device according to claim 1 and wherein said upper and lower running profiles each possess longitudinal slots of variable dimension as dictated by the number of supported elements and aligned along the lateral extent of said running profiles in the horizontal axis and so presenting an aspect to facilitate the rotation of said elements around an axis perpendicular to the horizontal axis of the lateral extent of said running profiles.

7) The device according to claim 1 wherein the number of rotational element pairs upon each coupling mechanism numbers four.

8) The device according to claim 1 wherein said joining components that facilitate the union of said engaging and otherwise coupling mechanisms and said upper and lower holding profiles include a spring-like suspension element.
